(19) United States
(12) Patent Application Publication
(10) Pub. No.: US 2021/0263509 A1
(43) Pub. Date: Aug. 26, 2021

(54) POSITION INFORMATION MANAGEMENT APPARATUS, POSITION INFORMATION MANAGEMENT SYSTEM, CONVEYANCE APPARATUS, POSITION INFORMATION MANAGEMENT METHOD, AND PROGRAM

(71) Applicant: MITSUBISHI HEAVY INDUSTRIES, LTD., Tokyo (JP)

(72) Inventor: Tatsuki TAKAZAKI, Tokyo (JP)

(21) Appl. No.: 16/972,723

(22) PCT Filed: Apr. 11, 2019
(86) PCT No.: PCT/JP2019/015782

§ 371 Date: Dec. 7, 2020

(30) Foreign Application Priority Data
Aug. 21, 2018 (JP) 2018-154771

(51) Int. Cl. G05B 19/418

(52) U.S. Cl. CPC G05B 19/41895; G05B 2219/50393

(57) ABSTRACT

A position information management apparatus for calculating position information about an object conveyed by a conveyance apparatus acquires conveyance position information indicating a position of the conveyance apparatus, load information indicating a load of the object on the conveyance apparatus, and initial position information indicating a position of the object when the object is loaded on the conveyance apparatus, and calculates the position information about the object loaded on the conveyance apparatus on the basis of the conveyance position information, the load information, and the initial position information.

### TECHNICAL FIELD

The present invention relates to a position information management apparatus, a position information management system, a conveyance apparatus, a position information management method, and a program.

The present application claims priority on the basis of Japanese Patent Application No. 2018-154771 filed in Japan on Aug. 21, 2018, the contents of which are incorporated herein by reference.

### BACKGROUND ART

It is necessary to grasp where a product being manufactured is present to perform production management in a factory and the like. For example, there is a method in which a transmission apparatus for transmitting a signal to each product is attached and the signal output by the transmission apparatus is received by another reception apparatus to grasp a position of the transmission apparatus. In this method, the position of the product is grasped by using the fact that a position of the product is the same as the position of the transmission apparatus.

In relation to management of position information, PTL discloses a technique in which positioning means is provided for each of a plurality of conveyance carriages and a controller acquires position information positioned by the positioning means of each of the conveyance carriages to grasp a position of the conveyance carriage in real time. PTL 2 discloses that a position detection sensor is provided in an item conveyance apparatus moving on a rail to manage a position of the item conveyance apparatus.

### CITATION LIST

### Patent Literature

[PTL 1] Japanese Unexamined Patent Application Publication No. 2008-150135

PTL 2: Japanese Unexamined Patent Application Publication No. 2011-219266

### SUMMARY OF INVENTION

### Technical Problem

However, the method of attaching the transmission apparatus to the product cannot be used in a case where the product is exposed to an environment in which the transmission apparatus cannot be used, since the transmission apparatus is required to be removed. This method cannot be used also in a case where the transmission apparatus cannot be attached to the product for some reason. On the contrary, there is a need for a method of grasping the position of the product without attaching anything to the product.

The present invention provides a position information management apparatus, a position information management system, a conveyance apparatus, a position information management method, and a program capable of solving the problems described above.

### Solution to Problem

According to one aspect of the present invention, a position information management apparatus for calculating position information about an object conveyed by a conveyance apparatus acquires conveyance position information indicating a position of the conveyance apparatus, load information indicating a load of the object on the conveyance apparatus, and initial position information indicating a position of the object when the object is loaded on the conveyance apparatus, and calculates the position information about the object loaded on the conveyance apparatus on the basis of the conveyance position information, the load information, and the initial position information.

According to one aspect of the present invention, the position information management apparatus determines that the object at the position indicated by the initial position information is loaded on the conveyance apparatus on the basis of the fact that the conveyance position information when the load information is acquired and the initial position information are included in the same area, and calculates the position information about the object after the load on the basis of the conveyance position information.

According to one aspect of the present invention, the position information management apparatus further acquires unload information indicating an unload of the object from the conveyance apparatus, and calculates position information about the object after the unload from the conveyance apparatus on the basis of the conveyance position information when the unload information is acquired.

According to one aspect of the present invention, the position information management apparatus calculates the conveyance position information on the basis of a detection result of position detection means provided in the conveyance apparatus.

According to one aspect of the present invention, the position information management apparatus stores latest position information about the object.

According to one aspect of the present invention, the position information management apparatus stores a history of the position information about the object.

According to one aspect of the present invention, the position information management apparatus outputs disposition map information in which the position information about the object is associated with map information including a movement range of the conveyance apparatus.

According to one aspect of the present invention, a position information management system includes a conveyance apparatus including position detection means for detecting data related to a position of a conveyance apparatus and load detection means for detecting a load of the object on the conveyance apparatus and an unload of the object from the conveyance apparatus, and the position information management apparatus according to any one of the above.

According to one aspect of the present invention, the conveyance apparatus includes position detection means for detecting data related to a position of the conveyance apparatus, and load detection means for detecting a load and an unload of an object on the conveyance apparatus.

According to one aspect of the present invention, a position information management method of calculating position information about an object conveyed by a conveyance apparatus includes a step of acquiring conveyance position information indicating a position of the conveyance apparatus, a step of acquiring load information indicating a load of the object on the conveyance apparatus, a step of acquiring initial position information indicating a position of the object when the object is loaded on the conveyance apparatus, and a step of calculating the position information about the object loaded on the conveyance apparatus on the basis of the conveyance position information, the load information, and the initial position information.

According to one aspect of the present invention, a program causes a computer to function as means for acquiring conveyance position information indicating a position of a conveyance apparatus, means for acquiring load information indicating a load of an object on the conveyance apparatus, means for acquiring initial position information indicating a position of the object when the load information is acquired, and means for calculating position information about the object loaded on the conveyance apparatus on the basis of the conveyance position information, the load information, and the initial position information.

### Advantageous Effects of Invention

With the position information management apparatus, the position information management system, the conveyance apparatus, the position information management method, and the program described above, it is possible to acquire the position of the object without attaching a sensor or the like for measuring a position of an object to the object.

### BRIEF DESCRIPTION OF DRAWINGS

FIG. 1 is a diagram showing an example of a position information management system according to an embodiment of the present invention.

FIGS. 2A, 2B, 2C, and 2D are diagrams showing a position information management method according to an embodiment of the present invention.

FIG. 3 is a diagram showing an example of a table for storing an initial position according to an embodiment of the present invention.

FIG. 4 is a diagram showing an example of a position information calculation table according to an embodiment of the present invention.

FIG. 5 is a diagram showing an example of a position information management table according to an embodiment of the present invention.

FIG. 6 is a diagram showing an example of a table for managing a history of position information according to an embodiment of the present invention.

FIG. 7 is a flowchart of position information management processing according to an embodiment of the present invention.

FIG. 8 is a diagram for describing a position information management method of a product according to an embodiment of the present invention.

FIG. 9 is a first diagram showing an example of a product management table according to an embodiment of the present invention.

FIG. 10 is a second diagram showing an example of a product management table according to an embodiment of the present invention.

FIG. 11 is a diagram showing an example of a hardware configuration of a position information management apparatus according to an embodiment of the present invention.

### DESCRIPTION OF EMBODIMENTS

### Embodiment

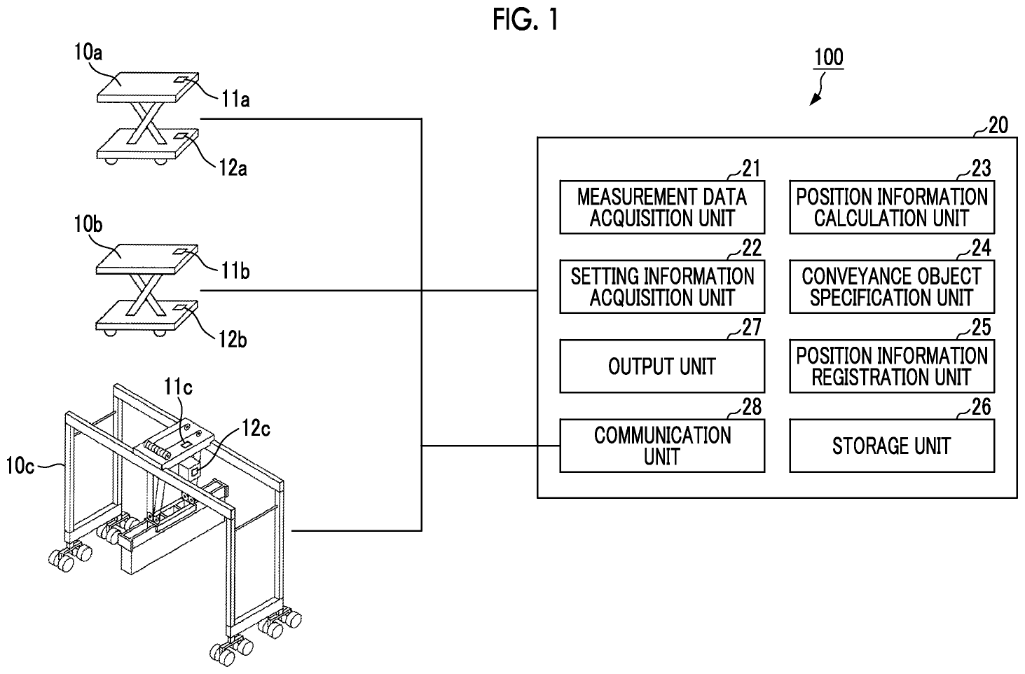

Hereinafter, position information management processing according to an embodiment of the present invention will be described with reference to FIGS. 1 to 11.

FIG. 1 is a diagram showing an example of a position information management system according to an embodiment of the present invention.

As shown in FIG. 1, the position information management system includes conveyance apparatuses 10a to 10c and a position information management apparatus 20.

With the position information management apparatus 20, for an object that is moved by the conveyance apparatuses 10a to 10c, an apparatus for transmitting a signal, a sensor for measuring position information about the target, or the like is not attached to the object (hereinafter referred to as target) and it is possible to grasp the position information about the target in real time. The conveyance apparatus 10a includes position detection means 11a for detecting data related to a current position of the conveyance apparatus and load detection means 12a for detecting load and unload of the target on the conveyance apparatus. Similarly, the conveyance apparatus 10b includes position detection means 11b and load detection means 12b, and the conveyance apparatus 10c includes position detection means 11c and load detection means 12c. When the conveyance apparatus 10a conveys the target, the position information management apparatus 20 acquires measurement data detected by the position detection means 11a and the load detection means 12a at that time to calculate a position of the target conveyed by the conveyance apparatus 10a. The conveyance apparatuses 10a and 10b illustrated in FIG. 1 are automated guided vehicles (AGVs), and the conveyance apparatuses 10c illustrated in FIG. 1 is a crane. The conveyance apparatuses 10a to 10c and the position information management apparatus 20 are communicably connected by a network or the like. For example, the conveyance apparatuses 10a to 10c include a communication apparatus and transmit the measurement data detected by each of the detection means (position detection means 11a, load detection means 12a, and the like) included in the apparatuses and identification information of the apparatuses to the position information management apparatus 20 by the communication apparatus. Alternatively, the conveyance apparatuses 10a to 10c may transmit the measurement data detected by each of the detection means and the identification information of each of the conveyance apparatuses 10a to 10c to the position information management apparatus 20 through a higher-level control apparatus (not shown) for controlling the conveyance apparatuses 10a to 10c.

As shown in FIG. 1, the position information management apparatus 20 includes a measurement data acquisition unit 21, a setting information acquisition unit 22, a position information calculation unit 23, a conveyance object specification unit 24, a position information registration unit 25, a storage unit. 26, an output unit 27, and a communication unit 28.

The measurement data acquisition unit 21 acquires the measurement data detected by the position detection means 11a and the load detection means 12a of the conveyance apparatus 10a. The same applies to the measurement data detected by each of the detection means included in the conveyance apparatuses 10b and 10c.

The setting information acquisition unit 22 acquires initial position information or the like that defines an initial position of the target.

The position information calculation unit 23 calculates a position of the conveyance apparatus 10a on the basis of the measurement data of the position detection means 11a acquired by the measurement data acquisition unit 21. The same applies to positions of the conveyance apparatuses 10b and 10c.

The conveyance object specification unit 24 specifies the target conveyed by the conveyance apparatus 10a on the basis of the measurement data of the position detection means 11a and the measurement data of the load detection means 12a which are acquired by the measurement data acquisition unit 21, and the initial position information acquired by the setting information acquisition unit 22. The same applies to the targets conveyed by the conveyance apparatuses 10b and 10c.

The position information registration unit 25 registers the position information about the target specified by the conveyance object specification unit 24 in the storage unit 26.

The storage unit 26 stores various kinds of information such as the position information about the target registered by the position information registration unit 25.

The output unit 27 outputs the current position of the target, the history of the position information, and the like which are stored in the storage unit 26.

The communication unit 28 communicates with another apparatus. For example, the communication unit 28 receives the measurement data detected by the position detection means 11a and the load detection means 12a from the conveyance apparatus 10a.

The position detection means 11a to 11c are, for example, GPS receivers, acceleration sensors, or RFID tags. With the position detection means 11a as an example, in the case of the GPS receiver, for example, the position detection means 11a receives the position information (latitude/longitude) of the conveyance apparatus 10a from a satellite or an indoor messaging system (IMES) at a predetermined time interval and the conveyance apparatus 10a transmits the latitude/longitude information to the position information management apparatus 20. In the position information management apparatus 20, the measurement data acquisition unit 21 acquires the latitude/longitude information through the communication unit 28. The position information calculation unit 23 converts the latitude and longitude into appropriate position information (for example, a section name of a position set within a site of a user). In a case where the position detection means 11a is the acceleration sensor, the position detection means 11a detects acceleration information at a predetermined time interval, and the conveyance apparatus 10a transmits the acceleration information to the position information management apparatus 20. In the position information management apparatus 20, the measurement data acquisition unit 21 acquires the acceleration information through the communication unit 28. The position information calculation unit 23 calculates a movement path (movement direction, movement distance) by integrating the acceleration information or the like and, for example, adds the movement path to the initial position information of the conveyance apparatus 10a to calculate the position information of the conveyance apparatus 10a.

In a case where the position detection means 11a is the RFID tag, a communication apparatus associated with the position information is disposed at a position through which the conveyance apparatus 10a passes at a predetermined interval. The communication apparatus transmits a power feeding radio wave. When the RFID tag approaches the communication apparatus, the tag is activated by receiving the power feeding radio wave and receives, from the communication apparatus, the position information of a position where the communication apparatus is installed. The conveyance apparatus 10a transmits the position information received by the RFID tag from the communication apparatus to the position information management apparatus 20. In the position information management apparatus 20, the measurement data acquisition unit 21 acquires the position information through the communication unit 28. The position information calculation unit 23 uses the acquired position information as the position information of the conveyance apparatus 10a. As another example of the position detection means 11a, a beacon signal receiver may be attached to the conveyance apparatus 10a, a beacon signal transmission apparatus associated with position information may be installed in each place within the site, and the beacon signal transmission apparatus may transmit the position information of the installation position of the apparatus to a receiver of the conveyance apparatus 10a by Bluetooth (registered trademark) Low Energy (BLE) or the like. For example, a method may be employed in which a plurality of wireless local area network (LAN) access points are installed within the site and the position detection means 11a communicates with an access point to estimate position information from position information about the communicating access point and radio wave intensity of the communication.

The load detection means 12a to 12c are, for example, load sensors, strain sensors, or weight scales. For example, the sensors are installed at a position where a weight of the target is added when the target is loaded on the conveyance apparatuses 10a to 10c. With the load detection means 12a as an example, for example, the load detection means 12a outputs measurement data (voltage, displacement amount, weight, and the like) at a predetermined time interval. The conveyance apparatus 10a transmits the measurement data to the position information management apparatus 20. In the position information management apparatus 20, the measurement data acquisition unit 21 acquires the measurement data through the communication unit 28. The conveyance object specification unit 24 determines whether the target is loaded on the conveyance apparatus 10a or whether the target is unloaded from the conveyance apparatus 10a, on the basis of the acquired measurement data. For example, in a case where the load detection means 12a outputs a voltage, the conveyance object specification unit 24 determines that the target is loaded when the voltage is equal to or larger than a predetermined threshold value and determines that the target is unloaded when the voltage is equal to or less than the predetermined threshold value.

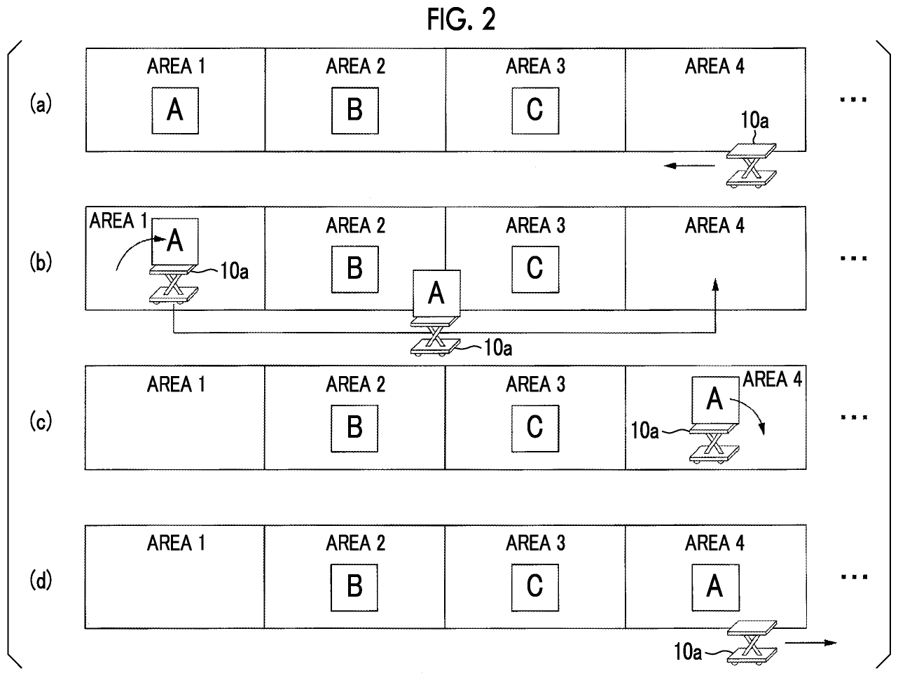

Next, a position information management method according to the present embodiment will be described with reference to FIGS. 2 to 6.

FIGS. 2A, 2B, 2C, and 2D are diagrams showing the position information management method according to an embodiment of the present invention.

FIG. 2A shows an initial position of the target. As shown in the figure, a target A is present in an area 1. A target B is present in an area 2, and a target C is present in an area 3. This state is set as the initial positions of the targets A to C. The position information management apparatus 20 stores the initial positions of the targets A to C. On the other hand, the conveyance apparatus 10a conveys the targets A to C to another area according to a conveyance instruction signal from the higher-level control apparatus (not shown). The position information management apparatus 20 updates the position information each time the targets A to C are conveyed to manage the position information about the target A and the like. The initial positions of the targets A to C stored in the position information management apparatus 20 will be described.

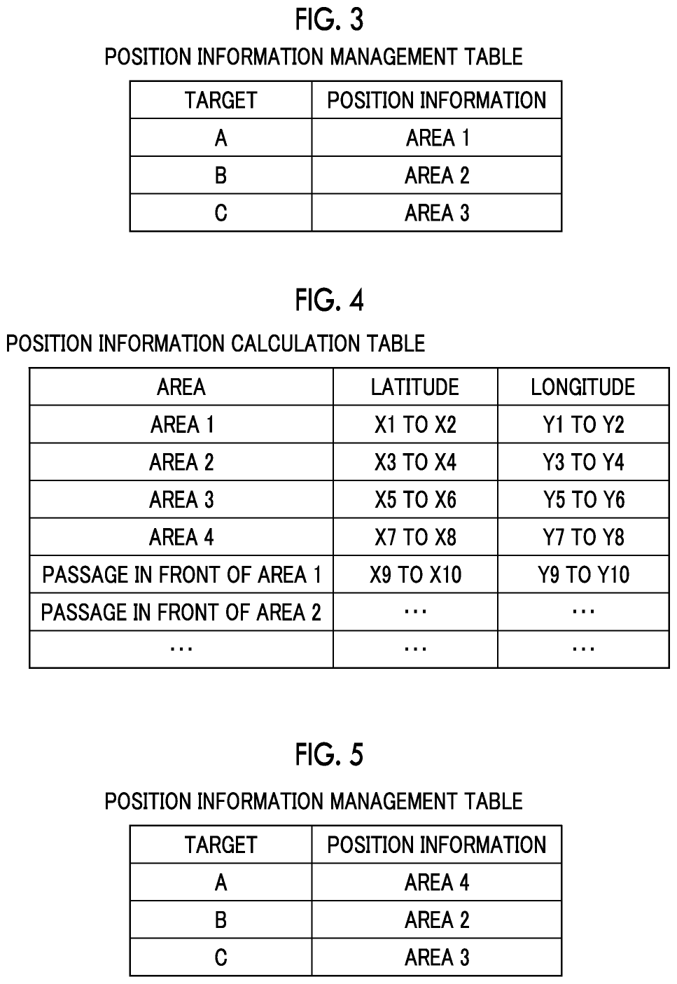

FIG. 3 is a diagram showing an example of a table for storing the initial positions according to an embodiment of the present invention.

As shown in the figure, a position information management table stores the targets A to C in association with the initial positions of the targets. The user inputs the initial positions of the targets A to C shown in FIG. 2A into the position information management apparatus 20. In the position information management apparatus 20, the setting information acquisition unit 22 acquires the input information and registers the information in the position information management table illustrated in FIG. 3. The position information management table is stored in the storage unit 26. The storage unit 26 may store the targets A to C and the initial positions of the targets as map information as presented in FIG. 2A.

First, the conveyance apparatus 10a moves to the area 1 according to a conveyance instruction signal defining that the target A is conveyed from the area 1 to an area 4. During this time, the conveyance apparatus 10a also transmits the measurement data related to the position information of the conveyance apparatus 10a detected by the position detection means 11a to the position information management apparatus 20. The conveyance apparatus 10a transmits the measurement data indicating whether or not the target is loaded on the conveyance apparatus 10a, which is detected by the load detection means 12a, to the position information management apparatus 20. The conveyance apparatus 10a transmits the measurement data of each of the detection means and the information (identification information of the conveyance apparatus 10a) indicating that the measurement data is measured by the conveyance apparatus 10a to the position information management apparatus 20. In the position information management apparatus 20, the measurement data acquisition unit 21 registers the measurement data, the identification information of the conveyance apparatus 10a, and a reception time point of the measurement data in the storage unit 26 in association with each other.

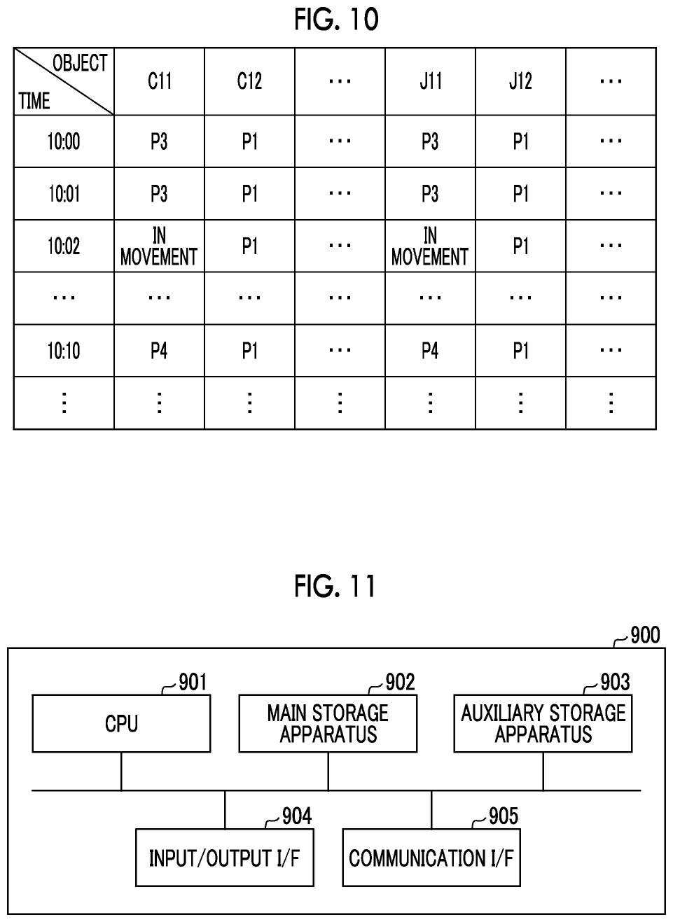

When the conveyance apparatus 10a arrives at the area 1, the user loads the target A on the conveyance apparatus 10a. This state is shown in FIG. 10B. At this time, the load detection means 12a transmits the measurement data indicating that the target A is loaded on the conveyance apparatus 10a to the position information management apparatus 20. The position detection means 11a transmits the measurement data related to the position information of the area 1 to the position information management apparatus 20. In the position information management apparatus 20, the measurement data acquisition unit 21 acquires the measurement data. The position information calculation unit 23 calculates the position of the conveyance apparatus 10a on the basis of the measurement data related to the position information. For example, in a case where the position information includes the latitude and longitude information, the position information calculation unit 23 calculates the position of the conveyance apparatus 10a with reference to a position information calculation table illustrated in FIG. 4.

FIG. 4 is a diagram showing an example of the position information calculation table according to an embodiment of the present invention.

As shown in the figure, the position information calculation table stores the areas 1 to 4 and the like in association with the position information (latitude and longitude) of the areas. The position information calculation unit 23 compares the latitude/longitude information acquired by the measurement data acquisition unit 21 with ranges of the latitude and the longitude set in the position information calculation table to calculate that the latitude/longitude information acquired by the measurement data acquisition unit 21 is included in ranges of the latitude and the longitude of the area 1 (latitude is X1 to X2, longitude is Y1 to Y2). Accordingly, the position information calculation unit 23 calculates that the conveyance apparatus 10a is present in the area 1. In a case where the position detection means 11a is the acceleration sensor, the position information calculation unit 23 may add the movement path of the conveyance apparatus 10a to the latitude/longitude of the initial position given to the conveyance apparatus 10a to calculate current latitude/longitude of the conveyance apparatus 10a. In a case where the position detection means 11a is the RFID tag or the like and the position information “area 1” is acquired from the communication apparatus or the like which is installed in the area 1 and stores that the installed place is the area 1, the position information calculation unit 23 can specify the position information of the conveyance apparatus 10a regardless of the position information calculation table.

The conveyance object specification unit 24 compares the measurement data acquired by the load detection means 12a with a predetermined threshold value to detect that some target is loaded on the conveyance apparatus 10a. When it is detected that the target is loaded, the conveyance object specification unit 24 specifies that the loaded object is the target A on the basis of the position information (area 1) of the conveyance apparatus 10a calculated by the position information calculation unit 23 and the position information management table illustrated in FIG. 3. More specifically, the conveyance object specification unit 24 specifies the target A by referring to a record in which a value of the position information in the position information management table is “area 1”. With the above processing, the position information management apparatus 20 can detect that the target A is loaded on the conveyance apparatus 10a in the area 1.

Next, the conveyance apparatus 10a moves to the area with the target A on the apparatus according to the conveyance instruction signal (FIG. 2B). During this time, the conveyance apparatus 10a transmits the measurement data by the position detection means 11a and the load detection means 12a to the position information management apparatus 20. The measurement data acquisition unit 21 acquires the measurement data, and the position information calculation unit 23 calculates the position information of the conveyance apparatus 10a in movement. The position information management apparatus 20 can manage the position information of the target A in movement.

When the conveyance apparatus 10a arrives at the area 4, the user unloads the target A from the conveyance apparatus 10a. This state is shown in FIGS. 2C and 2D. At this time, the conveyance apparatus 10a transmits measurement data indicating that the target A detected by the load detection means 12a is unloaded from the conveyance apparatus 10a to the position information management apparatus 20. The conveyance apparatus 10a transmits the measurement data related to the position information of the area 4 detected by the position detection means 11a to the position information management apparatus 20. In the position information management apparatus 20, the measurement data acquisition unit 21 acquires the measurement data. The position information calculation unit 23 calculates that the current position of the conveyance apparatus 10a is the area 4 in the same manner as the processing in the case where the target A is loaded in the area 1 described with reference to FIG. 2B. The conveyance object specification unit 24 determines that the target A is unloaded on the basis of the fact that the measurement data by the load detection means 12a falls below the predetermined threshold value. Then, the position information registration unit 25 updates the position information about the target A. Specifically, when the conveyance object specification unit 24 determines that the target A is unloaded, the position information registration unit 25 updates the position information about the target A in the position information management table with the position information (position information at the time when the target A is determined to be unloaded) calculated by the position information calculation unit 23. FIG. 5 shows the updated position information management table.

FIG. 5 is a diagram showing an example of the position information management table according to an embodiment of the present invention.

As shown in the figure, the position information about the target A is updated from “area 1” to “area 4” in the position information management table. The position information registration unit 25 may generate the map information illustrated in FIG. 2D showing the position information about the target, and the storage unit 26 may store the map information.

In this manner, with the position information management system 100, it is possible to calculate the position information about the target without attaching an apparatus, a sensor, or the like for detecting the position information to the target to be managed, and to grasp where the target is. In a factory and the like particularly, there is a production process in which a product being manufactured is processed by a machine tool, used with a chemical, submerged in a liquid, or heated at a high temperature. In such a production process, it is necessary to remove the sensor or the like attached to the product in advance, which is troublesome. There is a case where sensors may not be attached due to the nature of the product (size, material, or the like). It is costly because sensors are required to be prepared for each product. On the contrary, the conveyance apparatus 10a is rarely exposed to an environment in which the position detection means 11a and the like are required to be removed, on a path through which the conveyance apparatus 10a passes in the factory. Therefore, the position information management system 100 according to the present embodiment is suitable for introduction to the factory and the like. With the position information management system 100 according to the present embodiment, it is possible to automatically acquire and manage the position information of the product while executing the work of loading the product on the conveyance apparatus 10a every time one production process ends and conveying the product to a next work position according to a conventional work procedure without taking the trouble of attaching or detaching the sensors to and from the product. It is possible to reduce the cost since there is no need to purchase and manage the sensors to be attached to the product. PTL 1 and PTL 2 do not describe a method of managing the position information about the object conveyed by the conveyance apparatus on the basis of the measurement data by the position detection means and the load detection means provided in the conveyance apparatus.

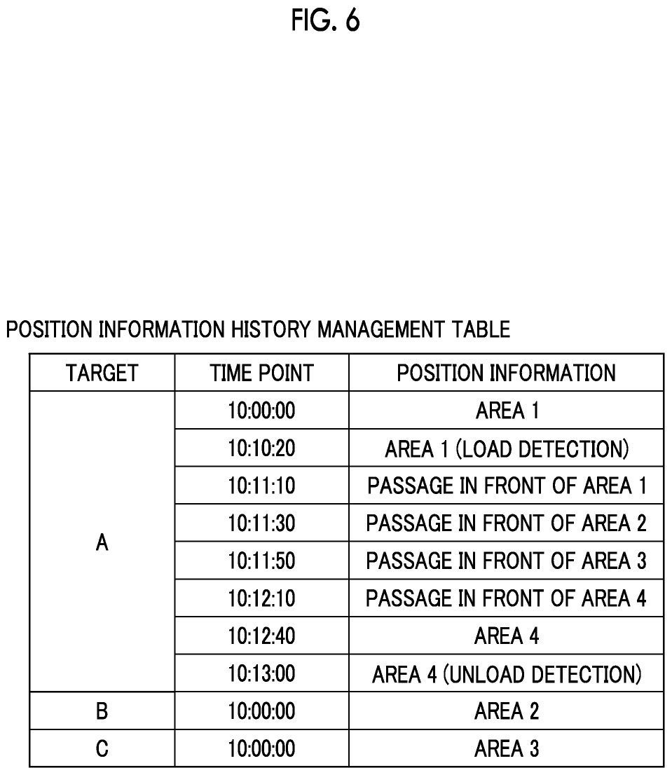

In the above, the case is described in which the position information management system 100 is used to grasp the latest position where the target A is placed. In addition to the above, the position information management system 100 can also be used for the purpose of tracking the position information about the target A being conveyed and grasping the movement history of the target A. In a case where the position information management system 100 is used for such a purpose, for example, the position information registration unit 25 registers the position information of the conveyance apparatus 10a calculated by the position information calculation unit 23 during the movement of the conveyance apparatus 10a in the storage unit 26. The storage unit 26 stores latest position information about the target A and the position information about the target A together with a time point when the position information calculation unit 23 calculates the position information. FIG. 6 shows an example of storing the position information about the target A being conveyed and the history of the position information.

FIG. 6 is a diagram showing an example of a table for managing the history of the position information according to an embodiment of the present invention.

In a position information history management table illustrated in FIG. 6, the position information registration unit 25 stores, for example, the history of the registered position information each time the position information of the conveyance apparatus 10a changes, for a period from when the conveyance object specification unit 24 determines that the targets A to C are loaded on the conveyance apparatus 10a until the conveyance object specification unit 24 determines that the targets A to C are unloaded from the conveyance apparatus 10a. A time point when the conveyance object specification unit 24 detects the load and unload of the target A is separately recorded. For example, all the targets A to C are present at the initial positions at 10 o'clock. When the user inputs the position information about the targets A to C at 10 o'clock, the position information registration unit 25 registers the position information about the targets A to C in the position information history management table together with the time points. Thereafter, when the conveyance object specification unit 24 detects that the target A is loaded on the conveyance apparatus 10a in the area 1, the position information registration unit 25 registers a time point (“10:00:20”) in the position information history management table. Thereafter, when the position information calculated by the position information calculation unit 23 changes from “area 1” to “passage in front of area 1”, the position information registration unit 25 registers “target A”, “passage in front of area 1”, and a changed time point (“10:11:10”) in the position information history management table in association with each other. Hereinafter, in the same manner, the position information registration unit 25 registers the above in the position information history management table each time the position information about the target A is switched, and registers a time point (“10:13:00”) when the target A is finally unloaded from the conveyance apparatus 10a. Thereafter, since the target A is not loaded on the conveyance apparatus 10a, the position information registration unit 25 does not register the position information about the target A. Since the targets B and the target C are not also loaded on the conveyance apparatus 10a, the position information registration unit 25 does not register the history of the position information.

With the position information history management table, it is possible for the user to grasp not only the current positions of the targets A to C but also the history of the position information up to the present or the movement path. It is possible for the user to track the target being conveyed.

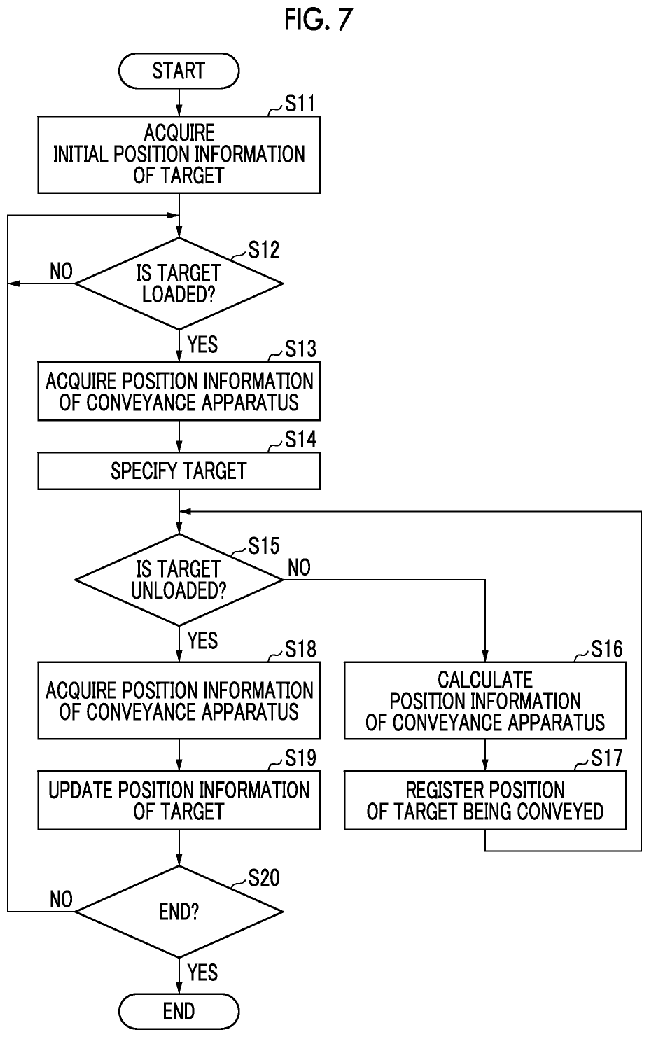

Next, a flow of the position information management processing will be described with the movement of the target A illustrated in FIGS. 2A, 2B, 2C, and 2D as an example with reference to FIG. 7. FIG. 7 is a flowchart of the position information management processing according to an embodiment of the present invention.

First, the setting information acquisition unit 22 acquires the position information of the initial positions of the targets A to C (step S11). The setting information acquisition unit 22 registers the position information of the initial position in the storage unit 26 (FIG. 3). The output unit 27 may generate the map information representing the disposition of the target illustrated in FIG. 2A and output the map information to a display apparatus or the like. The measurement data acquisition unit 21 continuously acquires the measurement data related to the position information of the conveyance apparatus 10a and the measurement data indicating the load and unload of the target on the conveyance apparatus 10a from the conveyance apparatus 10a at the predetermined time interval. The position information calculation unit 23 calculates the position information of the conveyance apparatus 10a on the basis of the measurement data related to the position information. The conveyance object specification unit 24 determines whether or not the target A is loaded on the conveyance apparatus 10a on the basis of the measurement data indicating the load and unload of the target acquired by the measurement data acquisition unit 21 (step S12). For example, when the voltage output by the load sensor (load detection means 12a) is equal to or larger than the predetermined threshold value, the conveyance object specification unit 24 determines that the target A is loaded. In a case where the load of the target A is not detected (step S12; No), this determination is repeated. In a case where the target A is determined to be loaded (step S12; Yes), the conveyance object specification unit 24 acquires, from the position information calculation unit 23, the position information of the conveyance apparatus 10a at the time point when the measurement data indicating that the target A is loaded is acquired (step S13). The conveyance object specification unit 24 specifies the target A loaded on the conveyance apparatus 10a on the basis of the initial position information about the targets A to C and the position information acquired in step S13 (step S14). The position information registration unit 25 may record the specified target A, the position information, and the current time point in the storage unit 26 (FIG. 6).

The measurement data acquisition unit 21 acquires the measurement data related to the position information and the measurement data indicating the load and unload of the targets A to C while the conveyance apparatus 10a conveys the target. Regardless of the load and unload of the targets A to C, the position information registration unit 25 may register the position information of the conveyance apparatus 10a in the storage unit 26 at the predetermined time interval, for example. Accordingly, it is possible to manage the position information of the conveyance apparatus 10a as well as the targets A to C.

Next, the conveyance object specification unit 24 determines whether or not the target A is unloaded from the conveyance apparatus 10a on the basis of the measurement data indicating the load and unload of the target acquired by the measurement data acquisition unit 21 (step S15). For example, when the voltage output by the load sensor (load detection means 12a) falls below the predetermined threshold value from the state of the predetermined threshold value or more, the conveyance object specification unit 24 determines that the target A is unloaded. In a case where the target A is determined to be unloaded (step S15; No), the position information calculation unit 23 calculates the position information of the conveyance apparatus 10a (step S16). The position information registration unit 25 registers the position information about the target A being conveyed in the storage unit 26 (step S17). For example, the position information registration unit 25 may record the target A, the position information, and the current time point in the storage unit 26 each time the position information calculated by the position information calculation unit 23 changes (FIG. 6). The output unit 27 may generate the map information (FIG. 2B and the like) that updates the position of the target A being conveyed each time the position information about the target A being conveyed changes, and output the map information to a display apparatus or the like.

In a case where the target A is determined to be unloaded (step S15; Yes), the conveyance object specification unit 24 acquires, from the position information calculation unit 23, the position information of the conveyance apparatus 10a at the time point when the measurement data indicating that the target A is unloaded is acquired (step S18). The position information registration unit 25 updates the position information about the target specified in step S14 as illustrated in FIG. 5 with the position information acquired in step S18 (step S19). In a case where the history of the position information is recorded, the position information registration unit 25 may register the position information and the time point of the position where the target A is unloaded as new history information as illustrated in FIG. 6. The output unit 27 may generate the map information (FIG. 2D) including the position information about the target A after the conveyance and output the map information to a display apparatus or the like.

Next, the position information management apparatus 20 determines whether or not to end the position information management processing (step S20). In a case where the position information management processing is continued, the processing after step S12 is repeated with the latest position information updated in step S19 as the initial position information for the target A conveyed this time. With the position information management method according to the present embodiment, it is possible to manage the position information about the targets A to C that are moved by the conveyance apparatuses 10a to 10c without attaching anything to the targets A to C.

In a case where the consistency between the content of the conveyance instruction signal output to the conveyance apparatus 10a by the higher-level control apparatus (not shown) and the load and unload position of the target is checked and, for example, the target A is unloaded at a position different from the area specified by the conveyance instruction signal, an alarm may be notified. The weight of each of the targets A to C may be further registered in addition to the content of the position information management table illustrated in FIG. 3. On the other hand, the conveyance apparatus 10a may be provided with the weight scale as the load detection means 12a, and the weight when the target A or the like is loaded may be collated with the registered weight to improve the specification accuracy of the target. For example, in a case where the weight of the target detected by the load detection means 12a is different from the weight of the target registered in advance, an alarm may be notified. In the examples of FIGS. 2A, 2B, 2C, and 2D, one target A or the like is disposed in one area. However, when the weight is used to specify the target, the targets having different weights may be disposed in the same area to specify the target loaded on the conveyance apparatus 10a by the weight of the target in addition to the position information of the position on which the target is loaded and the initial position information about the target.

(Implementation Example on Production Line)

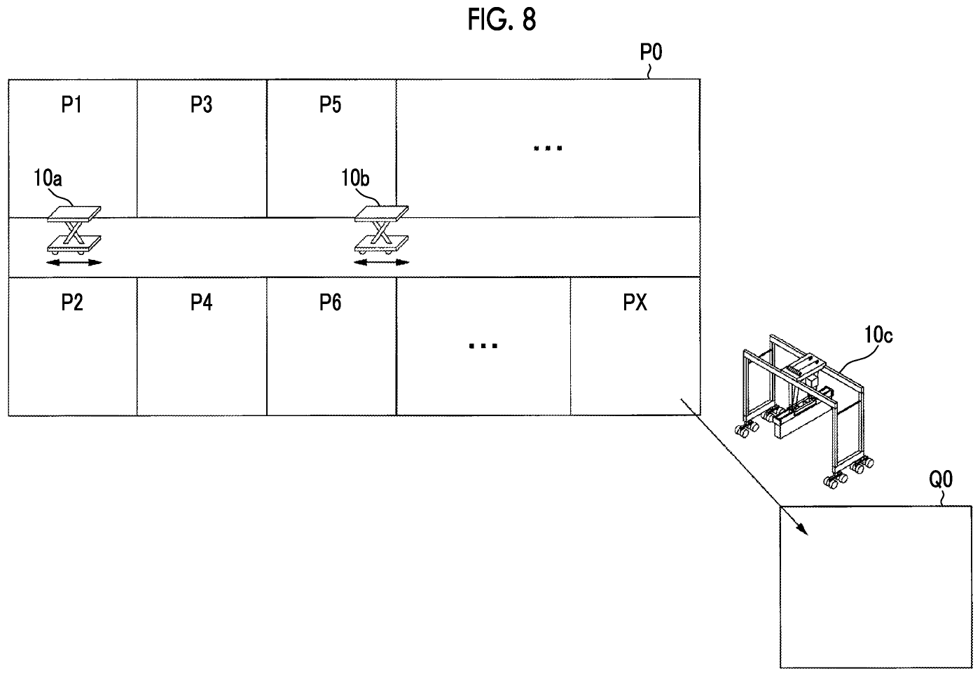

FIG. 8 is a diagram for describing the position information management method of the product according to an embodiment of the present invention.

An example of employing the position information management system 100 to a production line will be described with reference to FIG. 8.

FIG. 8 is a schematic diagram of a certain production line. In this production line, production is performed up to a process in an area P0 for a certain product α, and then a subsequent process is implemented in an area Q0 to finally complete the product α. The process performed in the area P0 is also divided into a plurality of production processes, and a work position where production work of the product α is performed is determined for each production process. In the figure, areas P1 to P6 and PX are work positions according to the production process. Assuming that the production processes are processes K1 to K6 in the order of the processes, for example, the production work of the process K1 is performed in the area P1, then the product a is conveyed to the area P2, and the process K2 is performed in the area P2. Hereinafter, in the same manner, the product α is conveyed to the areas P3 to P6 in this order, and the corresponding processes K3 to K6 are performed in each of the areas 3 to 6. The product α is finally conveyed to the area PX, and a final process X is performed in the area PX. In the areas P1 to PX, a maximum of one product α integrated with a jig or a single jig is disposed. The movement of the product α between the areas is performed by the conveyance apparatuses 10a and 10b (AGV). The conveyance apparatuses 10a and 10b conveys only one single jig or product α integrated with the jig at a time. When the production work in the area PX ends, the jig is removed from the product α, and the single product α is conveyed by the conveyance apparatus 10c (crane) to the area Q0 where the next process is performed. The conveyance apparatus 10c conveys only one single product α at a time. The conveyance apparatuses 10a to 10c load and unload the product α or the like only in the determined areas (areas P1 to P6, PX, and Q0) and move within a range where the position information can be acquired. The two conveyance apparatuses are not present in the same area at the same time.

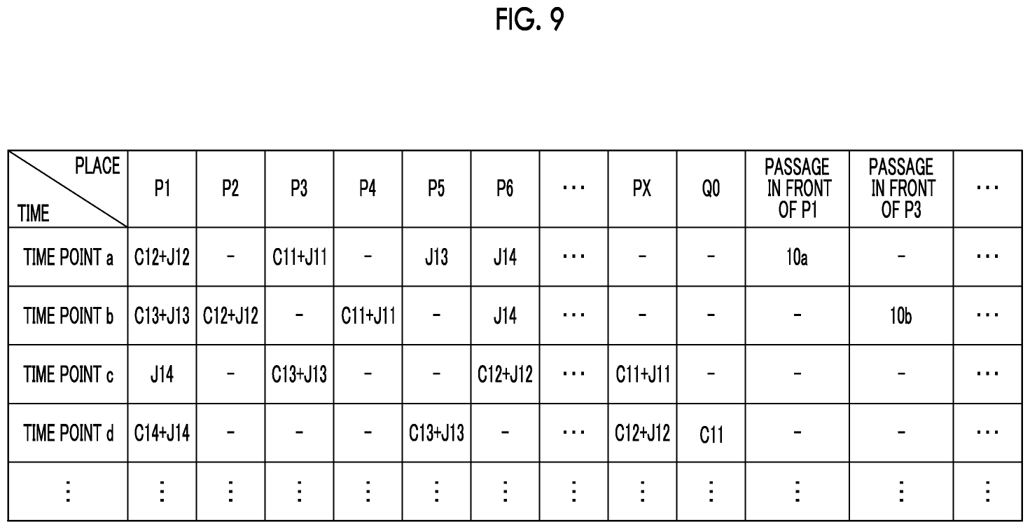

The processing described in the flowchart of FIG. 7 is performed for each of the conveyance apparatuses 10a to 10c, and thus it is possible to acquire the position information of each of the plurality of products α being worked in each of the production processes in the areas P1 to PX. It is possible to acquire the position information of the single jig in the areas P1 to PX. It is possible to acquire the position information of the conveyance apparatuses 10a to 10c. FIGS. 9 and 10 show examples of tables in which the position information of a product α, a jig, and the like are registered.

FIG. 9 is a first diagram showing an example of a product management table according to an embodiment of the present invention.

The product management table illustrated in FIG. 9 stores a disposition situation of the product α and the jig at each time point in the areas P1 to PX and the like, and the position information that the conveyance apparatus 10a and the like are present. A passage in front of P1 is a passage portion sandwiched between the area P1 and the area P2. A passage in front of P3 is a passage portion sandwiched between the area P3 and the area P4. C11 to C14 indicate the products α being manufactured, and J11 to J14 indicate the jigs. C11+J11 indicates that the product α (C11) and the jig (J11) are integrally configured. The history of the disposition situation of the product α and the jig is recorded for each area as shown in FIG. 9, and thus, for example, it is possible to grasp which product α and jig are currently present in which area. In other words, it is possible to grasp which product α is being worked in which production process. Therefore, it can be useful for production management in the factory and the like. As described above, it is not necessary to attach an apparatus for measuring the position to the product α. Therefore, it is possible to manage the position information of the product α without reducing the efficiency of the production work.

FIG. 10 is a second diagram showing an example of a product management table according to an embodiment of the present invention.

The product management table illustrated in FIG. 10 stores the position information of a position where each of the product α and the jig is disposed at each time point. A change in the position information with time is recorded for each target as shown in FIG. 10, and thus it is possible to grasp which product α and jig are currently present in which area. It is possible to grasp which product α is being worked in which production process. A staying time at each work position (time required for each work process) for each product α can be easily grasped. Therefore, it can be useful for progress management.

FIG. 11 is a diagram showing an example of a hardware configuration of the position information management apparatus according to an embodiment of the present invention. A computer 900 is, for example, a personal computer (PC) or a server terminal apparatus including a CPU 901, a main storage apparatus 902, an auxiliary storage apparatus 903, an input/output interface 904, and a communication interface 905. The computer 900 may include a processor such as a micro processing unit (MPU) or a graphics processing unit (GPU) instead of the CPU 901. The position information management apparatus 20 described above is mounted on the computer 900. The operation of each processing unit described above is stored in the auxiliary storage apparatus 903 in the form of a program. The CPU 901 reads the program from the auxiliary storage apparatus 903, expands the program in the main storage apparatus 902, and executes the above processing according to the program. The CPU 901 secures a storage area corresponding to the storage unit 26 in the main storage apparatus 902 according to the program. The CPU 901 secures a storage area for storing the data being processed in the auxiliary storage apparatus 903 according to the program.

In at least one embodiment, auxiliary storage apparatus 903 is an example of a non-transitory tangible medium. Other examples of the non-transitory tangible media include a magnetic disk, a magneto-optical disk, a CD-ROM, a DVD-ROM, and a semiconductor memory connected through the input/output interface 904. In a case where this program is distributed to the computer 900 by a communication line, the distributed computer 900 may expand the program in the main storage apparatus 902 and execute the above processing. The program may be for realizing a part of the function described above. Further, the program may be a so-called difference file (difference program) that realizes the function described above in combination with another program already stored in the auxiliary storage apparatus 903.

In addition, it is possible to replace the component in the embodiment described above with a well-known component as appropriate without departing from the spirit of the present invention. The technical scope of the present invention is not limited to the embodiment described above, and various modifications can be made without departing from the spirit of the present invention.

The map information of FIGS. 2A, 2B, 2C, and 2D and 8 is an example of disposition map information.

### INDUSTRIAL APPLICABILITY

With the position information management apparatus, the position information management system, the conveyance apparatus, the position information management method, and the program described above, it is possible to acquire the position of the object without attaching a sensor or the like for measuring a position of an object to the object.

### REFERENCE SIGNS LIST

100: position information management system
10a, 10b, 10c: conveyance apparatus
11a, 11b, 11c: position detection means
12a, 12b, 12c: load detection means
20: position information management apparatus
21: measurement data acquisition unit
22: setting information acquisition unit
23: position information calculation unit
24: conveyance object specification unit
25: position information registration unit
26: storage unit
27: output unit
28: communication unit
900: computer
901: CPU
902: main storage apparatus
903: auxiliary storage apparatus
904: input/output interface
905: communication interface

1. A position information management apparatus for calculating position information about an object conveyed by a conveyance apparatus, wherein
the position information management apparatus acquires conveyance position information indicating a position of the conveyance apparatus, load information indicating a load of the object on the conveyance apparatus, and initial position information indicating a position of the object when the object is loaded on the conveyance apparatus, and
calculates the position information about the object loaded on the conveyance apparatus on the basis of the conveyance position information, the load information, and the initial position information.

2. The position information management apparatus according to claim 1,
wherein the object at the position indicated by the initial position information is determined to be loaded on the conveyance apparatus on the basis of the fact that the conveyance position information when the load information is acquired and the initial position information are included in the same area, and the position information about the object after the load is calculated on the basis of the conveyance position information.

3. The position information management apparatus according to claim 1,
wherein unload information indicating an unload of the object from the conveyance apparatus is further acquired, and
position information about the object after the unload from the conveyance apparatus is calculated on the basis of the conveyance position information when the unload information is acquired.

4. The position information management apparatus according to claim 1,
wherein the conveyance position information is calculated on the basis of a detection result of position detection means provided in the conveyance apparatus.

5. The position information management apparatus according to claim 1,
wherein latest position information about the object is stored.

6. The position information management apparatus according to claim 1,
wherein a history of the position information about the object is stored.

7. The position information management apparatus according to claim 1,
wherein disposition map information in which the position information about the object is associated with map information including a movement range of the conveyance apparatus is output.

8. A position information management system comprising:
a conveyance apparatus including position detection means for detecting data related to a position of a conveyance apparatus and load detection means for detecting a load of the object on the conveyance apparatus and an unload of the object from the conveyance apparatus; and
the position information management apparatus according to claim 1.

9. A conveyance apparatus comprising:
position detection means for detecting data related to a position of the conveyance apparatus; and
load detection means for detecting a load and an unload of an object on the conveyance apparatus.

10. A position information management method of calculating position information about an object conveyed by a conveyance apparatus, comprising:
a step of acquiring conveyance position information indicating a position of the conveyance apparatus;
a step of acquiring load information indicating a load of the object on the conveyance apparatus;
a step of acquiring initial position information indicating a position of the object when the object is loaded on the conveyance apparatus; and
a step of calculating the position information about the object loaded on the conveyance apparatus on the basis of the conveyance position information, the load information, and the initial position information.

11. A program causing a computer to function as
means for acquiring conveyance position information indicating a position of a conveyance apparatus,
means for acquiring load information indicating a load of an object on the conveyance apparatus,
means for acquiring initial position information indicating a position of the object when the load information is acquired, and
means for calculating position information about the object loaded on the conveyance apparatus on the basis of the conveyance position information, the load information, and the initial position information.
